(19) United States
(12) Patent Application Publication
(10) Pub. No.: US 2004/0114188 A1
(43) Pub. Date: Jun. 17, 2004

(54) Image processing apparatus and image processing program storage medium

(75) Inventor: Takashi Toyofuku, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/730,974

(22) Filed: Dec. 10, 2003

(30) Foreign Application Priority Data
Dec. 12, 2002 (JP) 2002-360639
Nov. 11, 2003 (JP) 2003-381140

(51) Int. Cl. H04N 1/40; H04N 1/409

(52) U.S. Cl. 358/3.23; 358/2.1; 358/3.26

(57) ABSTRACT

The present invention is an apparatus and program storage medium storing a program for processing images, which receives CT image data and LW image data sent from an RIP, corrects and synthesizes the received CT image data and LW image data whereby generating an image data that represents an image having both a continuous gradation image region and a line drawing region, and sends the generated image data to a printer. Based on the received CT image data and LW image data, CT image data and LW image data to be corrected are obtained from the respective correction lookup tables, and a random number is added to each of the obtained CT image data and the LW image data to be corrected. The CT image data and the LW image data having the respective random numbers added are then synthesized and transmitted to the printer.

### BACKGROUND OF THE INVENTION

1. Field of the Invention

The present invention relates to an image processing apparatus which processes and synthesizes CT image data and LW image data to send the synthesized image data to a printer, and an image processing program storage medium having stored therein an image processing program, which is loaded to an information processing apparatus, and causes the information processing apparatus to operate as the image processing apparatus.

2. Description of the Related Art

Conventionally, in the printing industry, a DTP (Desk Top Publishing) system, which uses a personal computer or the like to edit or print a document, has been widely used. In this DTP system, an editing program (editing application) is used on an editing workstation such as a personal computer to perform editing work, which decides a layout including a pattern, a text, a line drawing, and the like representing an image, with a page description language (PDL). A result of the editing work is outputted as PDF (Portable Document Format) data, PS (Post Script) data, or the like. The outputted PDF data, PS data, or the like is inputted to an RIP (Raster Image Processor) serving as a so-called printer server.

The RIP converts the inputted PDF data, PS data, or the like for one page into CT (Continuous Tone) image data consisting of bitmap data representing a continuous gradation image and LW (Line Work) image data consisting of bitmap data representing a line drawing. Moreover, the RIP compresses the CT image data and the LW image data with different compression systems, respectively. For example, the RIP compresses the CT image and the LW image data with a JPEG system or the like and an LZW system or the like, respectively. Consequently, the RIP improves an average compression rate thereof and outputs the image data to an image processing apparatus.

The image processing apparatus is a communication unit interface apparatus called a BEP (Back End Processor). This image processing apparatus subjects the CT image data and the LW image data, which are outputted from the RIP by a unit of page, to expansion processing, and further subjects the image data to gradation correction processing by referring to a lookup table (see, for example, Japanese Patent Application Laid-Open No. 9-107463 (paragraphs 0018 to 0019, and FIG. 1) and outputs the image data to a printer.

The printer receives the image data from the image processing apparatus by a unit of page and prints the image data on a predetermined print sheet. As the printer, a so-called printer for on-demand printing is preferably used, with which a user can immediately print necessary information when it is necessary.

The conventional image processing apparatus subjects the CT image data and the LW image data to the gradation correction processing by referring to one lookup table. Thus, when the CT image data is subjected to appropriate gradation correction processing, it may be difficult to subject the LW image data to appropriate gradation correction processing. In that case, a quality of the LW image data is deteriorated. In addition, conversely, when the LW image data is subjected to appropriate gradation correction processing, it may be difficult to subject the CT image data to appropriate gradation correction processing. In that case, a quality of the CT image data is deteriorated. When such deteriorated CT image data and LW image data are sent to a printer, the printer outputs an image including both a region of a continuous gradation image and a region of a line drawing, in which a tone jump or the like causing a sudden change in a density occurs in an image printed by the printer. Therefore, it is difficult to obtain a high-quality print with the printer.

### SUMMARY OF THE INVENTION

The present invention has been devised in view of the above-described circumstances, and it is an object of the present invention to provide an image processing apparatus and an image processing program storage medium having image processing program stored therein, which generate image data for printing a high-quality image.

An image processing apparatus of the present invention attaining the object includes:

an image reception section which receives CT image data consisting of bitmap data representing a continuous gradation image and LW image data consisting of bitmap data representing a line drawing, in which the line drawing includes line, character, and graphics drawings;

a gradation correction section which performs gradation correction processing so as to correct the CT image data and the LW image data received by the image reception section, independently of each other;

an image synthesizing section which synthesizes the CT image data and the LW image data corrected by the gradation correction section, whereby generating image data representing an image including both a continuous gradation image region and a line drawing region; and

an image transmission section which sends the image data generated by the image synthesizing section to a printer.

The image processing apparatus of the present invention subjects CT image data representing an image in a region of a continuous gradation image and LW image data representing an image in a region of a line drawing to gradation correction processing independently of each other. Then, the image processing apparatus synthesizes CT image data after correction and LW image data after correction and sends the synthesized image data as image data representing an image including both the region of the continuous gradation image and the region of the line drawing to a printer. Consequently, image data for printing with both the CT image data and the LW image data subjected to appropriate gradation correction processing is generated, whereby a high-quality print is obtained based on the image data thus generated.

Here, the gradation correction section in the image processing apparatus of the present invention preferably has a correction lookup table for CT image and a correction lookup table for LW image, each of which describes association of data before correction and data after correction, and wherein the gradation correction section subjects the CT image data received by the image reception section to the gradation correction processing and subjects the LW image data received by the image reception section to the gradation correction processing, by referring to the correction lookup table for CT image and the correction lookup table for LW image respectively, whereby generating the corrected CT image data and the corrected LW image data.

Since the gradation correction section subjects the CT image data and the LW image data received by the image reception section to the respective gradation correction processing by referring to the respective correction lookup tables to thereby generate the respective image data after correction in this way, a quality of image data representing an image including both a region of a continuous gradation image and a region of a line drawing can be easily improved.

Further, it is also preferable that the gradation correction section in the image processing apparatus of the present invention adds a random number to data, which is obtained by referring to the correction lookup table for CT image, to thereby generate CT image data after correction with respect to CT image data received by the image reception section, and adds a random number to data, which is obtained by referring to the correction lookup table for LW image, to thereby generate LW image data after correction with respect to LW image data received by the image reception section.

When the gradation correction section is to add random numbers to data obtained by referring to these correction lookup tables in this way, these generated CT image data after correction and LW image data after correction are dispersed moderately. Therefore, a border of light and shade in a finally printed image changes gently, and occurrence of tone jump or the like can be suppressed.

In addition, an image processing program storage medium of the present invention attaining the object stores an image processing program, which is executed in an information processing apparatus executing a program and causes the information processing apparatus to operate as an image processing apparatus which includes:

an image reception section which receives CT image data consisting of bitmap data representing a continuous gradation image and LW image data consisting of bitmap data representing a line drawing, in which the line drawing includes line, character, and graphics drawings;

a gradation correction section which performs gradation correction processing so as to correct the CT image data and the LW image data received by the image reception section, independently of each other;

an image synthesizing section which synthesizes the CT image data and the LW image data corrected by the gradation correction section, whereby generating image data representing an image including both a continuous gradation image region and a line drawing region; and

an image transmission section which sends the image data generated by the image synthesizing section to a printer.

The image processing program stored in the image processing program storage medium of the present invention is executed in an information processing apparatus executing a program and causes the information processing apparatus to operate as the image processing apparatus. Thus, both of CT image data and LW image data are subjected to appropriate gradation correction processing, and a quality of image data representing an image including both of a region of a continuous gradation image and a region of a line drawing is improved. Therefore, image data for printing a high-quality image can be generated.

Here, the gradation correction section in the image processing program stored in the image processing program storage medium of the present invention preferably has a correction lookup table for CT image and a correction lookup table for LW image, each of which describes association of data before correction and data after correction, and wherein the gradation correction section subjects the CT image data received by the image reception section to the gradation correction processing and subjects the LW image data received by the image reception section to the gradation correction processing, by referring to the correction lookup table for CT image and the correction lookup table for LW image respectively, whereby generating the corrected CT image data and the corrected LW image data.

Consequently, a quality of image data representing an image including both of a region of a continuous gradation image and a region of a line drawing can be easily improved.

Further, it is also preferable that the gradation correction section in the image processing program stored in the image processing program storage medium of the present invention adds a random number to data, which is obtained by referring to the correction lookup table for CT image, to thereby generate CT image data after correction with respect to the CT image data received by the image reception section, and also adds a random number to data, which is obtained by referring to the correction lookup table for LW image, to thereby generate LW image data after correction with respect to the LW image data received by the image reception section.

Consequently, CT image data after correction and LW image data after correction are dispersed moderately. Therefore, a border of light and shade in a finally printed image changes gently, and occurrence of tone jump or the like can be suppressed.

According to the present invention, an image processing apparatus and an image processing program storage medium having image processing program stored therein, which generate image data for printing from which a high-quality print is obtained, can be provided.

### BRIEF DESCRIPTION OF THE DRAWINGS

In the accompanying drawings:

FIG. 1 is a diagram showing a system in which an embodiment of an image processing apparatus of the present invention is incorporated;

FIG. 2 is a diagram showing a hardware configuration of a computer shown in FIG. 1;

FIG. 3 is a diagram showing a functional block of an image processing apparatus 20;

FIG. 4 is a diagram showing a structure of an image processing section shown in FIG. 3; and

FIG. 5 is a conceptual diagram showing a CD-ROM 5_1 in which an image processing program for causing the image processing apparatus shown in FIG. 3 to operate.

### DETAILED DESCRIPTION OF THE PREFERRED EMBODIMENTS

Embodiments of the present invention will be hereinafter described.

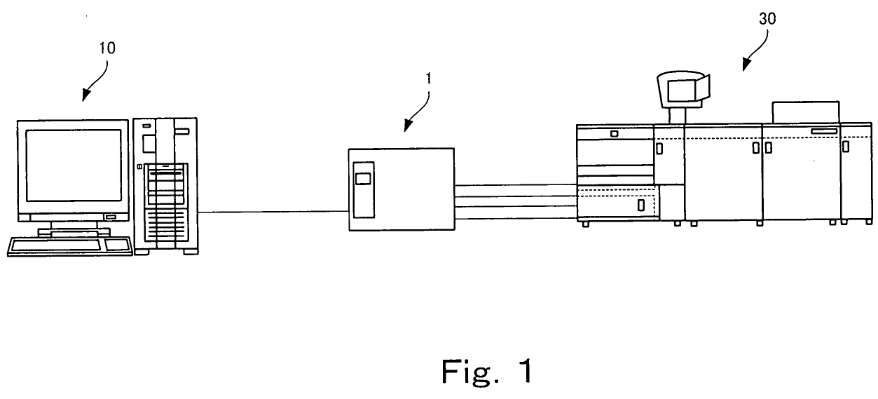

FIG. 1 is a diagram showing a system in which an embodiment of an image processing apparatus of the present invention is incorporated.

FIG. 1 shows an RIP (Raster Image Processor) 10, a computer 1, and a printer 30. An image processing program described later is uploaded to the computer 1 and executed, whereby the computer 1 operates as the embodiment of the image processing apparatus of the present invention.

The RIP 10 accepts PDF data, PS data, or the like input through an editing workstation such as a not-shown personal computer or the like, and converts the inputted PDF data, PS data, or the like into CT image data consisting of bitmap data representing a continuous gradation image and LW image data consisting of bitmap data representing a line drawing. The line drawing includes line, character, and graphics drawings. Moreover, the RIP 10 compresses the CT image data and the LW image data with, for example, a JPEG system or the like and an LZW system or the like, respectively. Consequently, the RIP 10 improves an average compression rate thereof and outputs the image data to the computer 1.

The computer 1 is a communication unit I/F apparatus called a BEP (Back End Processor). This computer 1 receives the CT image data and the LW image data from the RIP 10, subjects the received CT image data and LW image data to magnification correction processing independently of each other to synthesize the image data as described later, and sends the synthesized image data to the printer 30.

The printer 30 receives the image data from the computer 1 and prints the received image data on a predetermined print sheet. As the printer 30, a so-called printer for on-demand printing is preferably used, with which a user can immediately print necessary information when it is necessary.

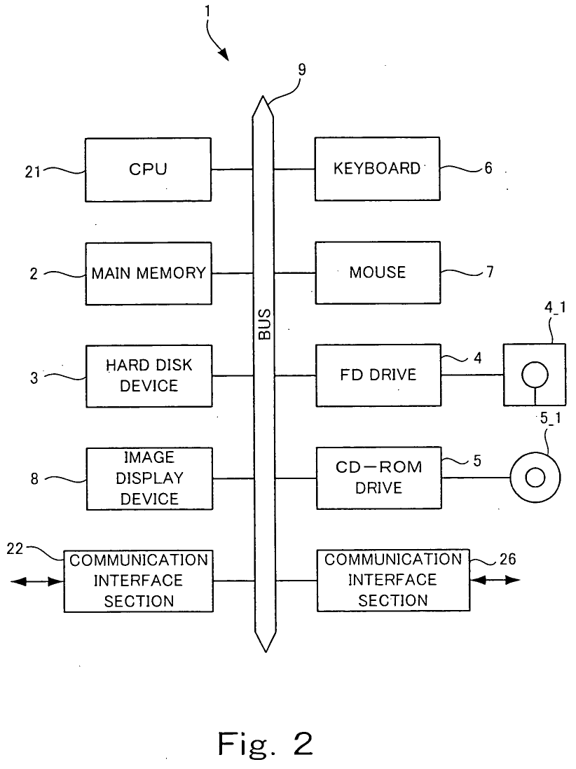

FIG. 2 is a diagram showing a hardware configuration of the computer 1 shown in FIG. 1.

The computer 1 includes: a CPU 21 executing various programs, a hard disk device 3 having stored therein various programs, data, and the like; and a main memory 2 to which a program stored in the hard disk device 3 is read out to be developed for execution in the CPU 21. The computer 1 further includes: an FD drive 4 accessing a flexible disk 4_1 (hereinafter abbreviated as FD 4_1); a CD-ROM drive 5 accessing a CD-ROM 5_1; a communication interface section 22 which is connected to the RIP 10 shown in FIG. 1 and receives a control command, CT image data, and LW image data from the RIP 10; and a communication interface section 26 which is connected to the printer 30 and sends image data to the printer 30. In addition, the computer 1 also includes an image display device 8 which displays an image in response to an instruction from the CPU 21, a keyboard 6 which accepts inputs of various kinds of information corresponding to key operation, and a mouse 7 which designates an arbitrary position on a screen of the image display device 8 to thereby input an instruction corresponding to an icon or the like displayed in the position. These various components are connected with each other via a bus 9.

Here, the CD-ROM 5_1 is an image processing program storage medium which is an embodiment of the image processing program storage medium of the present invention. The CD-ROM 5_1 is mounted to the CD-ROM drive 5, and an image processing program stored in the CD-ROM 5_1 is uploaded to the computer 1 and stored in the hard disk device 3. Then, this image processing program is started up and executed, whereby the computer 1 operates as an image processing apparatus 20 described later which is an embodiment of the image processing apparatus of the present invention.

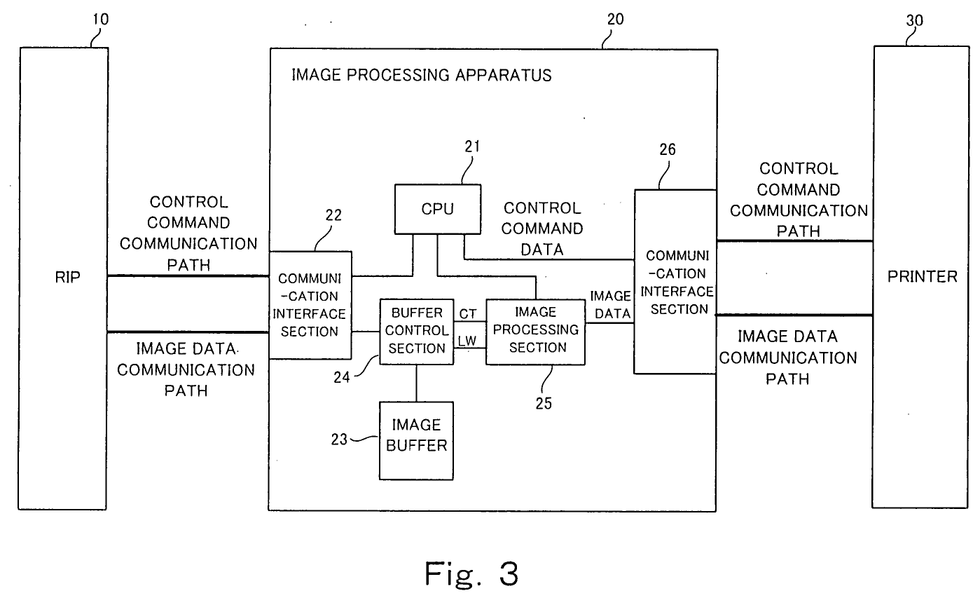

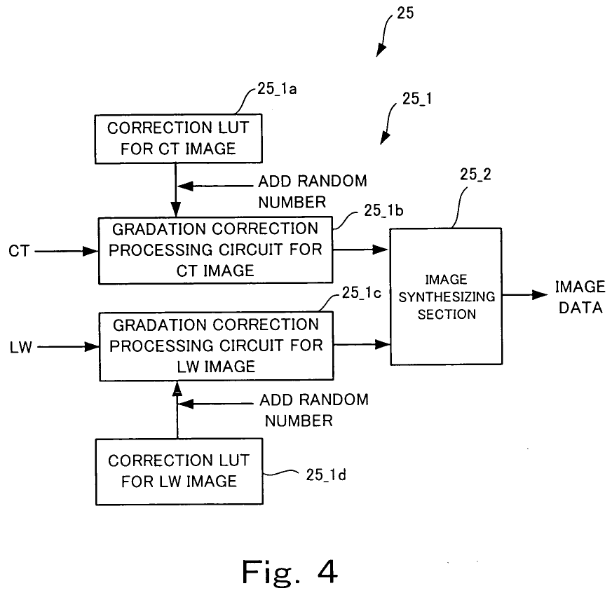

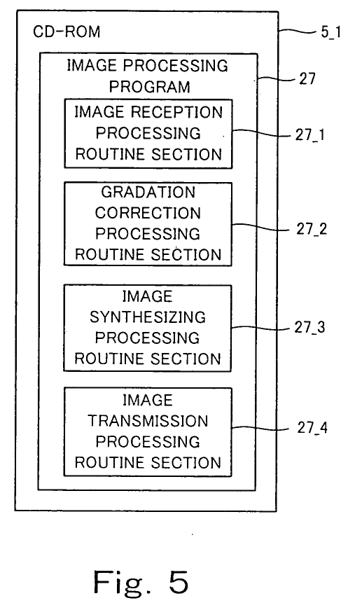

FIG. 3 is a diagram showing a functional block of the image processing apparatus 20. FIG. 4 is a diagram showing a structure of an image processing section shown in FIG. 3. FIG. 5 is a conceptual diagram showing the CD-ROM 5_1 having stored therein an image processing program for causing the image processing apparatus shown in FIG. 3 to operate.

First, an image processing program 27 stored in the CD-ROM 5_1 shown in FIG. 5 will be described. This image processing program 27 corresponds to an exemplary image processing program stored in the image processing program storage medium in the present invention. This image processing program 27 includes an image reception processing routine section 27_1, a gradation correction processing routine section 27_2, an image synthesizing processing routine section 27_3, and an image transmission processing routine section 27_4. Note that details of the respective sections of the image processing program 27 will be described together with actions of the respective sections of the image processing apparatus 20 shown in FIG. 3.

Next, the functional block of the image processing apparatus 20 shown in FIG. 3 will be described. The image processing apparatus 20 includes a CPU 21, a communication interface section 22, an image buffer 23, a buffer control section 24, an image processing section 25, and a communication interface section 26.

The CPU 21 executes various programs to thereby control the entire image processing apparatus 20.

The communication interface section 22 receives a control command from the RIP 10 through a control command communication path and, at the same time, receives CT image data and LW image data from the RIP 10 through an image data communication path.

The image buffer 23 is a buffer in which the CT image data and the LW image data received by the communication interface section 22 are stored.

The buffer control section 24 plays a role of controlling the image buffer 23 to store the CT image data and the LW image data from the communication interface section 22.

The communication interface section 22, the image buffer 23, and the buffer control section 24 correspond to an example of the image reception section in the present invention. The communication interface section 22, the image buffer 23, and the buffer control section 24 operate in response to an action of the image reception processing routine section 27_1 shown in FIG. 5, and the buffer control section 24 controls the image buffer 23 to store the CT image data and the LW image data received by the communication interface section 22.

The image processing section 25 will be described with reference to FIG. 4. As shown in FIG. 4, the image processing section 25 includes a gradation correction section 25_1 and an image synthesizing section 25_2. The gradation correction section 25_1 is composed of a correction LUT (lookup table) for CT image 25_1a, a gradation correction processing circuit for CT image 25_1b, a gradation correction processing circuit for LW image 25_1c, and a correction LUT for LW image 25_1d.

The gradation correction section 25_1 corresponds to an example of the gradation correction section in the present invention, and operates in response to an action of the gradation correction processing routine section 27_2 shown in FIG. 5 and subjects CT image data and LW image data from the buffer control section 24 to the gradation correction processing independently of each other as described below.

The correction LUT for CT image 25_1a constituting the gradation correction section 25_1 is a lookup table used for subjecting CT image data to the gradation correction processing, in which association of data before correction and data after correction is described.

The gradation correction processing circuit for CT image 25_1b subjects CT image data from the buffer control section 24 to the gradation correction processing by referring to the correction LUT for CT image 25_1a to thereby generate CT image data after correction. More specifically, the gradation correction processing circuit for CT image 25_1b adds a random number to data, which is obtained by referring to the correction lookup table for CT image 25_1a, to thereby generate CT image data after correction.

On the other hand, the correction LUT for LW image 25_1d is a correction lookup table used for subjecting the gradation correction processing to LW image data, in which association of data before correction and data after correction is described.

The gradation correction processing circuit for LW image 25_1c subjects LW image data from the buffer control section 24 to the gradation correction processing by referring to the correction LUT for LW image 25_1d to thereby generate LW image data after correction. More specifically, the gradation correction processing circuit for LW image 25_1c adds a random number to data, which is obtained by referring to the correction lookup table for LW image 25_1d, to thereby generate LW image data after correction.

The image synthesizing section 25_2 corresponds to an example of the image synthesizing section in the present invention, and operates in response to an action of the image synthesizing processing routine section 27_3 shown in FIG. 5. The image synthesizing section 25_2 synthesizes the CT image data after correction generated by the gradation correction processing circuit for CT image 25_1b and the LW image data after correction generated by the gradation correction processing circuit for LW image 25_1c to generate image data representing an image including both a region of a continuous gradation image and a region of a line drawing. The image data generated by the image synthesizing section 25_2 is outputted to the communication interface section 26.

Referring back to FIG. 3, the communication interface section 26 corresponds to an example of the image transmission section in the present invention. The communication interface section 26 operates in response to an action of the image transmission processing routine section 27_4 shown in FIG. 5 and sends the control command from the CPU 21 and the image data generated by the image synthesizing section 25_2 to the printer 30 through a control command communication path and an image data communication path.

The image processing apparatus 20 of this embodiment subjects CT image data representing an image in a region of a continuous gradation image to the gradation correction processing by referring to the correction LUT for CT image 25_1a to thereby generate CT image data after correction and, at the same time, subjects LW image data representing an image in a region of a line drawing to the gradation correction processing by referring to the correction LUT for LW image 25_1d to thereby generate LW image data after correction. Since both the CT image data and the LW image data are thus subjected to appropriate gradation correction processing, a quality of image data representing an image including both the region of a continuous gradation image and the region of a line drawing is improved. Therefore, image data for printing a high-quality image can be generated.

Further, the image processing apparatus 20 adds a random number to data obtained by referring to the correction LUT for CT image 25_1a and to data obtained by referring to the correction LUT for LW image 25_1d, using the gradation correction processing circuit for CT image 25_1b and the gradation correction processing circuit for LW image 25_1c, to thereby generate CT image data after correction and LW image data after correction respectively. As a result, the CT image data after correction and the LW image data after correction are dispersed moderately, so that borders of light and shade in a finally printed image can change gently, and occurrence of a tone jump or the like can be suppressed.

Note that the present invention has been described using the gradation correction section 25_1 as an example, which subjects the CT image data and the LW image data to the gradation correction processing by referring to the correction LUT for CT image 25_1a and the correction LUT for LW image 25_1d and by adding a random number to these data to thereby generate CT image data after correction and LW image data after correction respectively. However, the gradation correction section in the present invention is not limited to this example, but may be any type as long as the gradation correction section subjects CT image data and LW image data to gradation correction independently of each other to thereby generate CT image data after correction and LW image data after correction respectively.

What is claimed is:

1. An image processing apparatus comprising:
an image reception section which receives CT image data consisting of bitmap data representing a continuous gradation image and LW image data consisting of bitmap data representing a line drawing, in which the line drawing includes line, character, and graphics drawings;
a gradation correction section which performs gradation correction processing so as to correct the CT image data and the LW image data received by the image reception section, independently of each other;
an image synthesizing section which synthesizes the CT image data and the LW image data corrected by the gradation correction section, whereby generating image data representing an image including both a continuous gradation image region and a line drawing region; and
an image transmission section which sends the image data generated by the image synthesizing section to a printer.

2. An image processing apparatus according to claim 1,
wherein the gradation correction section comprises a correction lookup table for CT image and a correction lookup table for LW image, each of which describes association of data before correction and data after correction, and wherein the gradation correction section subjects the CT image data received by the image reception section to the gradation correction processing and subjects the LW image data received by the image reception section to the gradation correction processing, by referring to the correction lookup table for CT image and the correction lookup table for LW image respectively, whereby generating the corrected CT image data and the corrected LW image data.

3. An image processing apparatus according to claim 2,
wherein the gradation correction section adds a random number to data obtained by referring to the correction lookup table for CT image, to thereby generate CT image data after correction with respect to the CT image data received by the image reception section, and also adds a random number to data obtained by referring to the correction lookup table for LW image, to thereby generate LW image data after correction with respect to the LW image data received by the image reception section.

4. An image processing program storage medium storing an image processing program which is executed in an information processing apparatus executing a program and causes the information processing apparatus to operate as an image processing apparatus, the image processing apparatus comprising:
an image reception section which receives CT image data consisting of bitmap data representing a continuous gradation image and LW image data consisting of bitmap data representing a line drawing, in which the line drawing includes line, character, and graphics drawings;
a gradation correction section which performs gradation correction processing so as to correct the CT image data and the LW image data received by the image reception section, independently of each other;
an image synthesizing section which synthesizes the CT image data and the LW image data corrected by the gradation correction section, whereby generating image data representing an image including both a continuous gradation image region and a line drawing region; and
an image transmission section which sends the image data generated by the image synthesizing section to a printer.

5. An image processing program storage medium according to claim 4,
wherein the gradation correction section comprises a correction lookup table for CT image and a correction lookup table for LW image, each of which describes association of data before correction and data after correction, and wherein the gradation correction section subjects the CT image data received by the image reception section to the gradation correction processing and subjects the LW image data received by the image reception section to the gradation correction processing, by referring to the correction lookup table for CT image and the correction lookup table for LW image respectively, whereby generating the corrected CT image data and the corrected LW image data.

6. An image processing program storage medium storing an image processing program according to claim 5,
wherein the gradation correction section adds a random number to data obtained by referring to the correction lookup table for CT image, to thereby generate CT image data after correction with respect to the CT image data received by the image reception section, and also adds a random number to data obtained by referring to the correction lookup table for LW image, to thereby generate LW image data after correction with respect to the LW image data received by the image reception section.
